(19) United States
(12) Patent Application Publication
(10) Pub. No.: US 2025/0238961 A1
(43) Pub. Date: Jul. 24, 2025

(54) ENCODING AND DECODING METHODS, ENCODER, DECODER, AND STORAGE MEDIUM

(71) Applicant: GUANGDONG OPPO MOBILE TELECOMMUNICATIONS CORP., LTD., Dongguan (CN)

(72) Inventors: Zhan MA, Dongguan (CN); Xining WANG, Dongguan (CN); Honglian WEI, Dongguan (CN)

(73) Assignee: GUANGDONG OPPO MOBILE TELECOMMUNICATIONS CORP., LTD., Dongguan (CN)

(21) Appl. No.: 19/174,098

(22) Filed: Apr. 9, 2025

Related U.S. Application Data
(63) Continuation of application No. PCT/CN2022/126026, filed on Oct. 18, 2022.

(51) Int. Cl. G06T 9/00; H04N 19/54

(52) U.S. Cl. CPC G06T 9/001; H04N 19/54

(57) ABSTRACT

Embodiments of the present application provide encoding and decoding methods. At a decoding end, a decoder decodes a bitstream to determine displacement coefficient information of a current frame; determines at least one coefficient block from the displacement coefficient information based on a first scan order; determines a plurality of displacement coefficients based on the at least one coefficient block and a second scan order; and determines a reconstructed mesh based on the plurality of displacement coefficients and a decimated mesh of the current frame.

### CROSS-REFERENCE TO RELATED APPLICATIONS

This application is a continuation of International Application No. PCT/CN2022/126026, filed on Oct. 18, 2022, the disclosure of which is hereby incorporated by reference in its entirety.

### TECHNICAL FIELD

Embodiments of this application relate to the field of mesh compression coding technologies, and in particular, to a coding method, an encoder, a decoder, and a storage medium.

### BACKGROUND

In standard reference software of dynamic mesh coding (Dynamic Mesh Coding) provided by the moving picture experts group (Moving Picture Experts Group, MPEG), the coding of geometric information of a mesh mainly includes organization and compression of displacement coefficients corresponding to an original mesh.

However, currently, a common method for organizing displacement coefficients is not optimal, resulting in increasing of a bit rate of subsequent lossless encoding of a displacement coefficient, thereby reducing the mesh compression performance.

### SUMMARY

Embodiments of this application provide a coding method, an encoder, a decoder, and a storage medium, so that a better strategy for organizing displacement coefficients is used to reduce a bit rate for encoding a displacement coefficient, thereby improving mesh compression performance.

The technical solutions in embodiments of this application may be implemented as follows:

According to a first aspect, an embodiment of this application provides a decoding method, applied to a decoder, where the method includes:
decoding a bitstream to determine displacement coefficient information of a current frame;
determining at least one coefficient block from the displacement coefficient information based on a first scan order;
determining a plurality of displacement coefficients based on the at least one coefficient block and a second scan order; and
determining a reconstructed original mesh of the current frame based on the plurality of displacement coefficients and a decimated mesh of the current frame.

According to a second aspect, an embodiment of this application provides a decoding method, applied to a decoder, where the decoder includes a video decoder and a mesh decoder, and the method includes:
the mesh decoder is configured to decode a bitstream to determine a decimated mesh of a current frame; and
the video decoder is configured to execute the decoding method according to the first aspect.

According to a third aspect, an embodiment of this application provides an encoding method, applied to an encoder, where the method includes:
determining a plurality of displacement coefficients based on a plurality of displacement vectors of a current frame;
sequentially traversing the plurality of displacement coefficients based on a second scan order to determine at least one coefficient block;
determining displacement coefficient information of the current frame based on the at least one coefficient block and a first scan order; and
writing the displacement coefficient information into a bitstream.

According to a fourth aspect, an embodiment of this application provides an encoding method, applied to an encoder, where the encoder includes a video encoder, a mesh encoder, and a preprocessor, and the method includes:
the preprocessor is configured to generate a decimated mesh and a displacement vector based on an original mesh of a current frame;
the mesh encoder is configured to encode the decimated mesh to generate a bitstream of the decimated mesh; and
the video encoder is configured to execute the encoding method according to the second aspect.

According to a fifth aspect, an embodiment of this application provides an encoder, where the encoder includes a first determining unit and an encoding unit,
where the first determining unit is configured to: determine a plurality of displacement coefficients based on a plurality of displacement vectors of a current frame; sequentially traverse the plurality of displacement coefficients based on a second scan order to determine at least one coefficient block; and determine displacement coefficient information of the current frame based on the at least one coefficient block and a first scan order; and
the encoding unit is configured to write the displacement coefficient information into a bitstream.

According to a sixth aspect, an embodiment of this application provides an encoder, where the encoder includes a first memory and a first processor,
where the first memory is configured to store a computer program runnable by the first processor; and
the first processor is configured to run the computer program to execute the method according to the third aspect or the fourth aspect.

According to a seventh aspect, an embodiment of this application provides a decoder, where the decoder includes a decoding unit and a second determining unit,
where the decoding unit is configured to decode a bitstream; and
the second determining unit is configured to: determine displacement coefficient information of a current frame; determine at least one coefficient block from the displacement coefficient information based on a first scan order; determine a plurality of displacement coefficients based on the at least one coefficient block and a second scan order; and determine a reconstructed original mesh of the current frame based on the plurality of displacement coefficients and a decimated mesh of the current frame.

According to an eighth aspect, an embodiment of this application provides a decoder, including a second memory and a second processor,
where the second memory is configured to store a computer program runnable by the second processor; and
the second processor is configured to run the computer program to execute the method according to the first aspect or the second aspect.

According to a ninth aspect, an embodiment of this application provides a computer-readable storage medium, where the computer-readable storage medium stores a computer program, and the computer program is used to, when being executed, implement the method according to the first aspect or the second aspect, or implement the method according to the third aspect or the fourth aspect.

### BRIEF DESCRIPTION OF DRAWINGS

FIG. 1 is a diagram of an overall framework of mesh coding.

FIG. 2 is a schematic diagram of mesh preprocessing.

FIG. 3 is a schematic diagram of intra encoding.

FIG. 4 is a schematic diagram of inter encoding.

FIG. 5 is a schematic diagram of intra decoding.

FIG. 6 is a schematic diagram of inter decoding.

FIG. 7 is a schematic diagram of a network architecture of coding according to an embodiment of this application.

FIG. 8 is a schematic diagram of a decoding method according to an embodiment of this application.

FIG. 9 is a schematic diagram of displacement coefficient information.

FIG. 10 is a first schematic diagram of video padding.

FIG. 11 is a second schematic diagram of video padding.

FIG. 12 is a first schematic diagram of frame padding.

FIG. 13 is a second schematic diagram of frame padding.

FIG. 14 is a schematic diagram of a raster scan order.

FIG. 15 is a schematic diagram of a first scan order.

FIG. 16 is a schematic diagram of a unit block.

FIG. 17 is a first schematic diagram of a coefficient block.

FIG. 18 is a second schematic diagram of a coefficient block.

FIG. 19 is a schematic diagram of a Z-scan order.

FIG. 20 is a schematic diagram of a second scan order.

FIG. 21 is a schematic diagram of displacement coefficients.

FIG. 22 is a first schematic diagram of organizing displacement coefficients.

FIG. 23 is a second schematic diagram of organizing displacement coefficients.

FIG. 24 is a third schematic diagram of organizing displacement coefficients.

FIG. 25 is a schematic diagram of an encoding method according to an embodiment of this application.

FIG. 26 is a first schematic structural diagram of an encoder.

FIG. 27 is a second schematic structural diagram of an encoder.

FIG. 28 is a first schematic structural diagram of a decoder.

FIG. 29 is a second schematic structural diagram of a decoder.

### DESCRIPTION OF EMBODIMENTS

To understand features and technical content of embodiments of this application in more detail, the following describes implementation of embodiments of this application in detail with reference to the accompanying drawings. The accompanying drawings are merely used for description, and are not intended to limit embodiments of this application.

Unless otherwise defined, all technical and scientific terms used in this specification have the same meaning as those commonly understood by those skilled in the art within this application. The terms used in this specification are merely intended to describe embodiments of this application, and are not intended to limit this application.

The following description relates to “some embodiments” which describe subsets of all possible embodiments. However, it may be understood that “some embodiments” may be the same subset or different subsets of all possible embodiments and may be combined with each other without conflict.

It should be further noted that the term “first\second\third” in embodiments of this application is merely intended to distinguish between similar objects but does not represent a specific order of objects. It may be understood that “first\second third” may interchange a specific order or sequence if allowed, such that embodiments in this application described herein are capable of being implemented in an order different from that illustrated or described herein.

It should be noted that bitstreams of different data formats may be decoded and combined in a same video scenario, and at least an image format, a point cloud (Point Cloud) format, and a mesh (mesh) format may be included. In this manner, real-time immersive video interaction services can be provided by a plurality of data formats (for example, a mesh format, a point cloud format, and an image format) with different sources.

In embodiments of this application, a data format-based method may allow independent processing at a bitstream level in a data format. That is, like tiles (tiles) or slices (slices) in video encoding, different data formats in this scenario may be independently encoded, so that independent encoding and decoding can be performed based on a data format.

Generally, three-dimensional animation content is represented based on a key frame, that is, each frame is a static mesh. Static meshes at different instants have a same topology structure and different geometric structures. However, a data volume of a three-dimensional dynamic mesh represented based on a key frame is particularly large, so how to implement effective storage, transmission, and drawing becomes a problem faced in development of the three-dimensional dynamic mesh. In addition, different user terminals (a computer, a notebook, a portable device, and a mobile phone) need to support spatial scalability of a mesh, and different network bandwidths (broadband, narrowband, and wireless) need to support quality scalability of a mesh. Therefore, compression of the three-dimensional dynamic mesh is a very critical issue.

Current methods for compressing a three-dimensional dynamic mesh include: a space-time based prediction method in which compression efficiency is improved by eliminating spatial and temporal correlations; a principal components analysis (Principal Components Analysis, PCA)-based technology in which projecting is performed in a feature vector space to concentrate energy; and a wavelet-based method supporting spatial scalability and quality scalability.

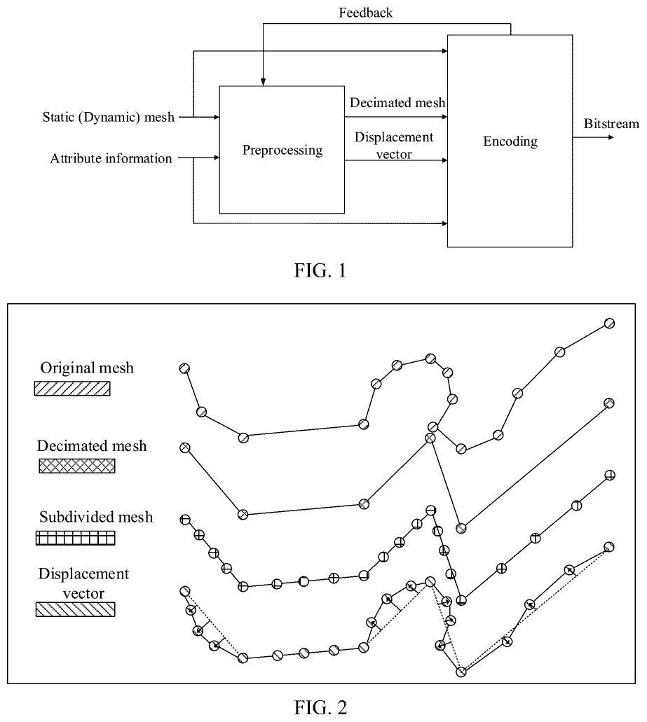

It should be noted that FIG. 1 is a diagram of an overall framework of mesh coding, and FIG. 2 is a schematic diagram of mesh preprocessing. As shown in FIG. 1 and FIG. 2, there are mainly two parts at an encoding side: preprocessing (Pre-processing) and an encoder (Encoder). In a preprocessing process, an original mesh (Original Mesh) is first decimated to obtain a decimated mesh (Decimated Mesh), which is referred to as a base mesh (Base Mesh). Then the decimated mesh is subdivided to obtain a subdivided mesh (Subdivided Mesh). Finally, for each vertex in the subdivided mesh, a point closest to the vertex in the original mesh is found, and a displacement vector (Displacement) of the two points is calculated. After the preprocessing, the decimated mesh and the displacement vector are input to an encoder to generate a bitstream.

Further, in an encoding process, based on different types of processed frames, encoders may be classified into an intra encoder and an inter encoder which respectively perform intra encoding and inter encoding.

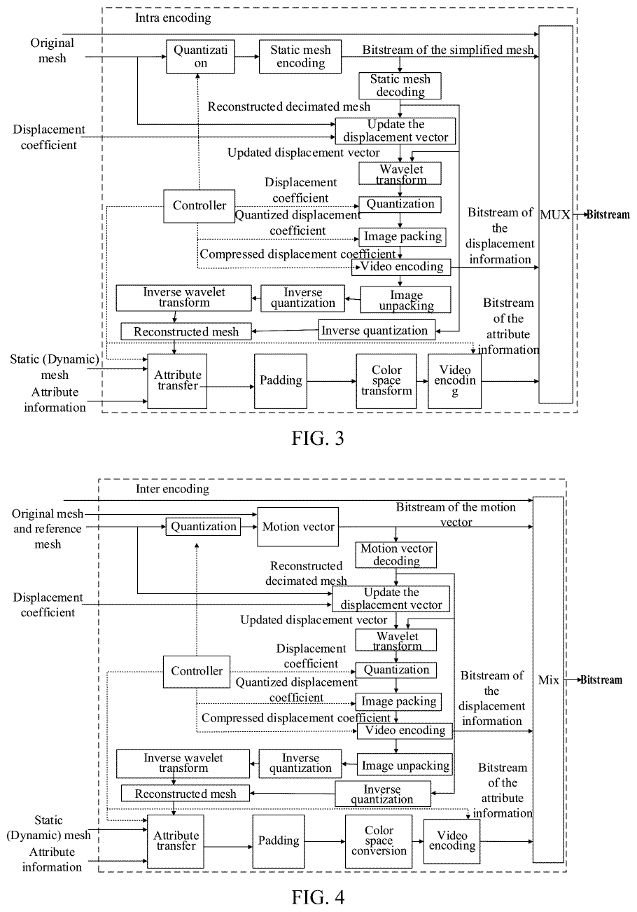

FIG. 3 is a schematic diagram of intra encoding. As shown in FIG. 3, in an intra encoder, a common static mesh encoder (Static Mesh Encoder) may be used to encode a decimated mesh to generate a corresponding bitstream (Compressed base mesh bitstream). Then, a displacement vector is updated (Update Displacements) by using a reconstructed decimated mesh, and wavelet transform (Wavelet Transform) is performed on the updated displacement vector to obtain a displacement coefficient. After being packed into an image or a video (Image Packing and Video Packing), the displacement coefficient is encoded through high efficiency video coding (High Efficiency Video Coding, H.265-HEVC) to generate a bitstream of the displacement coefficient (Compressed displacements bitstream). For attribute map (Attribute Map) coding, a feature map is first transformed (Texture Transfer) based on a difference between reconstructed geometric information and original geometric information, and then padded (Padding), packed (Video Packing), and then encoded by a video encoder to form an attribute bitstream (Compressed attribute bitstream).

FIG. 4 is a schematic diagram of inter encoding. As shown in FIG. 4, a procedure of an inter encoder is substantially the same as that of the intra encoder, but the inter encoder does not directly encode a decimated mesh, but encodes a motion vector (Motion Encoder) between a decimated mesh of a current frame and a decimated mesh of a reference frame, and generates a bitstream of the corresponding motion vector (Compressed motion bitstream).

Correspondingly, in a decoding process, based on different types of processed frames, decoders may be classified into an intra decoder and an inter decoder which respectively perform intra decoding and inter decoding.

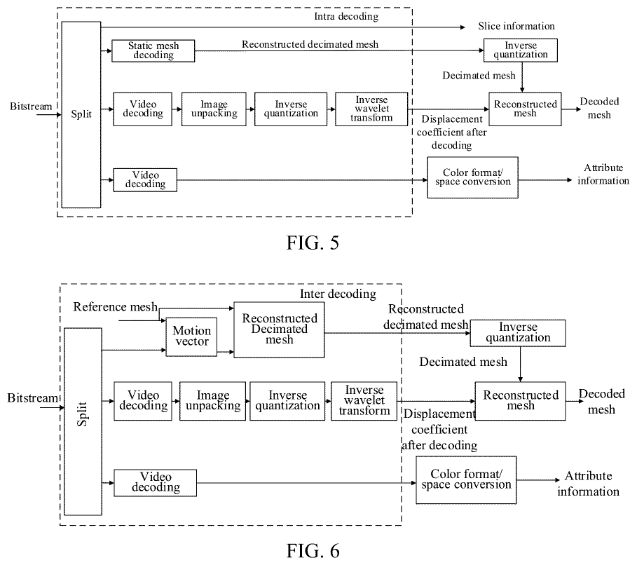

FIG. 5 is a schematic diagram of intra decoding. As shown in FIG. 5, in an intra decoder, a static mesh decoder (Static Mesh Decoder) may be used for decoding to obtain a decimated mesh. A video decoder (Video Decoder) is used for decoding to obtain a displacement coefficient video, and a displacement coefficient is obtained through video unpacking (Video Unpacking) and inverse wavelet transform (Inverse Wavelet Transform). Decoded mesh geometric information is obtained by using the decimated mesh and the displacement coefficient obtained by means of decoding. An attribute map is decoded directly by the video decoder.

FIG. 6 is a schematic diagram of inter decoding. As shown in FIG. 6, a procedure of an inter decoder is basically the same as that of the intra decoder. A motion vector is decoded instead of decoding a decimated mesh directly, and a decimated mesh of a current frame is obtained through calculation based on a decimated mesh of a previous frame (a reference frame).

In view of above, in standard reference software (hereinafter referred to as standard reference software) of dynamic mesh coding (Dynamic Mesh Coding) provided by the moving picture experts group (Moving Picture Experts Group, MPEG), a process of encoding geometric information includes the following steps:
1. Decimate an original mesh. Specifically, a quantity of vertices in a mesh is reduced and a connection relationship is simplified.
2. Subdivide the decimated mesh obtained in step 1. Specifically, for any two vertices in step 1 that have a connection relationship, a new point is added at a middle point of a line segment of the vertices, and this operation is repeated twice.
3. For each vertex obtained in step 2, find a point closest to the vertex in the original mesh, and calculate a displacement vector (Displacement) of the two points.
4. Encode the decimated mesh obtained in step 1 by using an existing static network encoder such as Draco.
5. Adjust the displacement vector obtained in step 3 based on a reconstructed decimated mesh obtained in step 4.
6. Perform wavelet transform on the displacement vector obtained in step 5, and organize displacement vectors (hereinafter referred to as displacement coefficients) obtained by the wavelet transform into a video.
7. Perform lossless encoding on the displacement coefficient obtained in step 6 by using a standard video encoder such as H.265.

It should be noted that, in a process of performing wavelet transform on a displacement vector and organizing displacement coefficients obtained through the transform into a video in the reference software, the displacement coefficients are organized in an order from a low-frequency coefficient to a high-frequency coefficient. Specifically, in the reference software, transformed displacement vectors are traversed in ascending order of frequency, and organized into a 16×16 square block based on a Z-scan order, and finally square blocks are organized into a video frame based on a raster scan order.

However, in experiments, the foregoing manner of organizing displacement coefficients is not optimal, and consequently, a bit rate for subsequent lossless encoding of a displacement coefficient is increased, and mesh compression performance is reduced.

To resolve the foregoing problem, embodiments of this application provide a coding method. At a decoding side, a decoder decodes a bitstream to determine displacement coefficient information of a current frame; determines at least one coefficient block from the displacement coefficient information based on a first scan order; determine a plurality of displacement coefficients based on the at least one coefficient block and a second scan order; and determines a reconstructed original mesh of the current frame based on the plurality of displacement coefficients and a decimated mesh of the current frame. At an encoding side, an encoder determines a plurality of displacement coefficients based on a plurality of displacement vectors of a current frame; sequentially traverses the plurality of displacement coefficients based on a second scan order to determine at least one coefficient block; determines displacement coefficient information of the current frame based on the at least one coefficient block and a first scan order; and writes the displacement coefficient information into a bitstream. It can be learned that, in embodiments of this application, in compressing the geometric information of a mesh is compressed during coding, displacement coefficients may be traversed based on the first scan order to determine coefficient blocks, and the coefficient blocks may be traversed based on the second scan order to determine the displacement coefficient information. In the displacement coefficient information of the current frame obtained based on the first scan order and the second scan order, high-frequency information is located on an upper left side of the frame, and low-frequency information is located on a lower right side of the frame, so that the high-frequency information with low complexity can be first processed, and can be used as a reference during subsequent processing of the low-frequency information with high complexity. In other words, in embodiments of this application, a better strategy for organizing displacement coefficients is used to reduce a bit rate for encoding a displacement coefficient, thereby improving mesh compression performance.

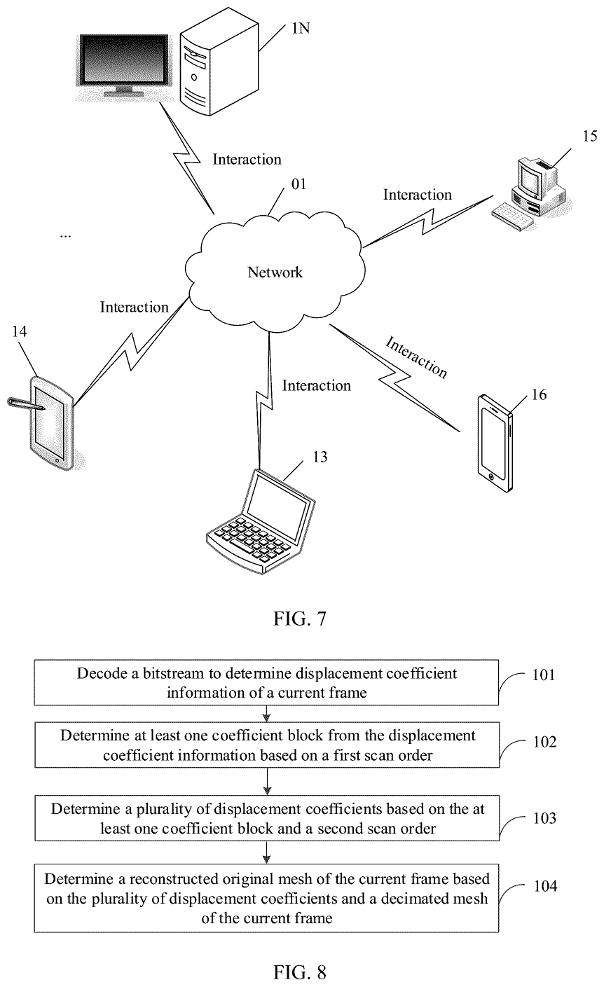

Embodiments of this application provide a network architecture of a coding system including a decoding method and an encoding method. FIG. 7 is a schematic diagram of a network architecture of coding according to an embodiment of this application. As shown in FIG. 7, the network architecture includes one or more electronic devices 13 to 1N and a communications network 01. The electronic devices 13 to 1N may perform video interaction by using the communications network 01. In an implementation process, the electronic device may be various types of devices with a coding function. For example, the electronic device may include a mobile phone, a tablet computer, a personal computer, a personal digital assistant, a navigator, a digital telephone, a video telephone, a television set, a sensing device, and a server. This is not limited in embodiments of this application. The decoder or the encoder in embodiments of this application may be the foregoing electronic device.

The following clearly and fully describes the technical solutions in embodiments of this application with reference to the accompanying drawings of embodiments of this application.

An embodiment of this application provides a decoding method. FIG. 8 is a schematic diagram of a decoding method according to an embodiment of this application. As shown in FIG. 8, in this embodiment of this application, a method for performing decoding processing by a decoder may include the following steps:
Step 101: Decode a bitstream to determine displacement coefficient information of a current frame.

In this embodiment of this application, the decoder may first decode the bitstream to determine the displacement coefficient information of the current frame.

It should be noted that in this embodiment of this application, the decoder may be a video decoder, or may be any decoding apparatus including a video decoder and a mesh decoder.

Further, in this embodiment of this application, a bitstream transmitted to the decoder may be a bitstream of a displacement coefficient, or may be bitstream data including a bitstream of a displacement coefficient and a bitstream of a decimated mesh (or a bitstream of a motion vector).

It may be understood that in this embodiment of this application, the current frame may be a current image frame or a current video frame. This application sets no specific limitation.

It should be noted that in this embodiment of this application, the displacement coefficient information of the current frame may include at least one level of details (Level of Details, LOD) including at least one coefficient block.

It may be understood that in this embodiment of this application, the at least one level of details in the displacement coefficient information may be arranged in ascending order of frequency. A level of details including high-frequency information is located on a left side and/or an upper side of a level of details including low-frequency information.

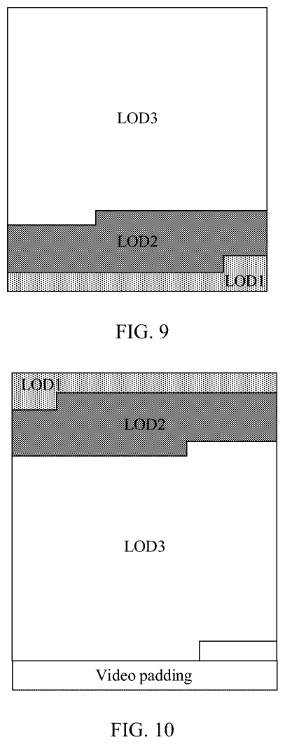

For example, in this embodiment of this application, FIG. 9 is a schematic diagram of displacement coefficient information. As shown in FIG. 9, in displacement coefficient information including three levels of details (an LOD1, an LOD2, and an LOD3), the LOD1 includes lowest-frequency information, the LOD2 includes higher-frequency information, and the LOD3 includes highest-frequency information. The LOD1 including the lowest-frequency information is most complex, and the LOD3 including the highest-frequency information is most simple. The LOD3 including the highest-frequency information is located on an upper left side of the LOD1 including the lowest-frequency information.

Further, in this embodiment of this application, for the displacement coefficient information determined by decoding the bitstream, if a quantity of rows of the displacement coefficient information is less than a preset height threshold, video padding (Video Padding) may be performed on the displacement coefficient information based on a preset value and the preset height threshold.

It may be understood that in this embodiment of this application, the preset value may be an integer greater than 0. For example, the preset value is 512, and the preset height threshold may be a maximum height in a mesh sequence, that is, a height (a quantity of rows) corresponding to a frame with a largest quantity of displacement coefficients in the mesh sequence.

For example, in this embodiment of this application, if the quantity of rows of the displacement coefficient information of the current frame is less than the quantity of rows corresponding to the frame with the largest quantity of displacement coefficients in the mesh sequence, that is, is less than the preset height threshold, the constant 512 may be selected for video padding, so that heights (quantities of rows) of all frames in the mesh sequence are the same, that is, it is ensured that each frame in the mesh sequence has a constant height.

It should be noted that in this embodiment of this application, in standard reference software, a width of a video frame (or an image frame) of displacement coefficients may be a fixed constant. For a mesh sequence, because quantities of displacement coefficients of all frames are not necessarily equal, heights of video frames (or image frames) formed by different frames are not necessarily equal. Therefore, a video frame (or an image frame) with a smaller height needs to be padded, to ensure that a height of each video frame of displacement coefficients is constant.

It may be understood that in this embodiment of this application, a first position may be a position above a last LOD in the displacement coefficient information. In this application, levels of details in the displacement coefficient information are sequentially arranged from the lower right to the upper left in ascending order of frequency. Therefore, during video padding, padding processing may be performed above the last level of details including high-frequency information.

For example, in this embodiment of this application, FIG. 10 is a first schematic diagram of video padding. As shown in FIG. 10, commonly, levels of details in the displacement coefficient information are sequentially arranged from the upper left to the lower right in ascending order of frequency. Therefore, during video padding, displacement coefficient information of a current frame may be padded at the bottom.

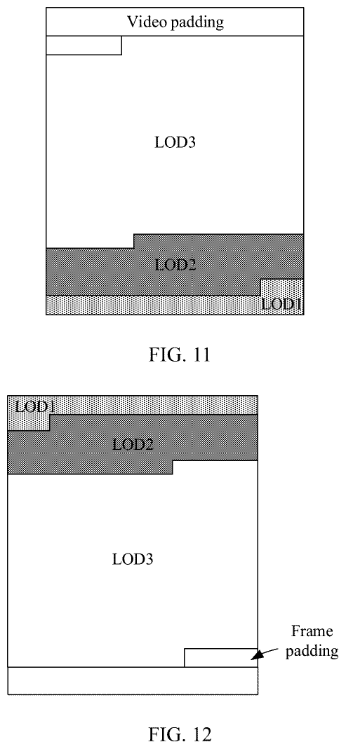

For example, in this embodiment of this application, FIG. 11 is a second schematic diagram of video padding. As shown in FIG. 11, in this application, levels of details in the displacement coefficient information are sequentially arranged from the lower right to the upper left in ascending order of frequency. Therefore, during video padding, displacement coefficient information of a current frame may be padded at the top.

Further, in this embodiment of this application, for the displacement coefficient information determined by decoding the bitstream, if there is a vacant part in a last row in the displacement coefficient information, frame padding (Frame Padding) may be performed on the displacement coefficient information based on a second position and a preset value.

It may be understood that in this embodiment of this application, the preset value may be an integer greater than 0. For example, the preset value is 512.

For example, in this embodiment of this application, if there is a vacant part in the last row in the displacement coefficient information of the current frame, frame padding may be performed by using the constant 512, so that displacement coefficient information corresponding to each frame in a mesh sequence is rectangular, that is, it is ensured that at least one LOD forms rectangular displacement coefficient information.

It may be understood that in this embodiment of this application, the second position may be a position on an upper left side of a last LOD in the displacement coefficient information. In this application, levels of details in the displacement coefficient information are sequentially arranged from the lower right to the upper left in ascending order of frequency. Therefore, during frame padding, padding processing may be performed on the upper left side of the last level of details including high-frequency information.

For example, in this embodiment of this application, FIG. 12 is a first schematic diagram of frame padding. As shown in FIG. 12, commonly, levels of details in the displacement coefficient information are sequentially arranged from the upper left to the lower right in ascending order of frequency. Therefore, during frame padding, a vacant part in a lower right corner of displacement coefficient information of a current frame may be padded.

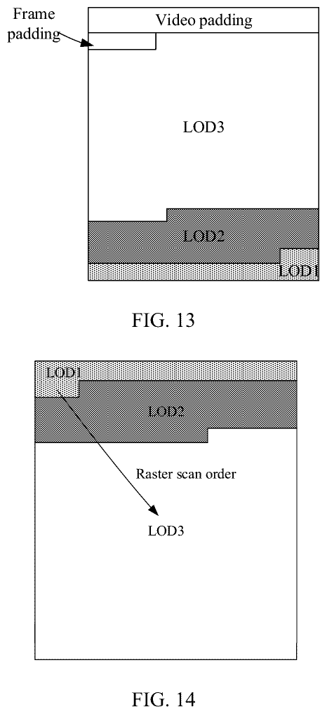

For example, in this embodiment of this application, FIG. 13 is a second schematic diagram of frame padding. As shown in FIG. 13, in this application, levels of details in the displacement coefficient information are sequentially arranged from the lower right to the upper left in ascending order of frequency. Therefore, during frame padding, a vacant part in an upper left corner of displacement coefficient information of a current frame may be padded.
Step 102: Determine at least one coefficient block from the displacement coefficient information based on a first scan order.

In this embodiment of this application, after the displacement coefficient information of the current frame is determined by decoding the bitstream, the decoder may further determine the at least one coefficient block from the displacement coefficient information based on the first scan order.

It should be noted that in this embodiment of this application, based on an arrangement order of levels of details in the displacement coefficient information, the decoder may sequentially traverse, based on the first scan order, a level of details including low-frequency information and a level of details including high-frequency information.

It may be understood that in this embodiment of this application, the first scan order may be a reverse scan order of a raster scan order. Raster scan (RasterScan) refers to a process of scanning from left to right and top to bottom and moving to a start position of a next row to continue scanning after completing one row. The raster scan order is mainly used in a common coding procedure.

It should be noted that in this embodiment of this application, when levels of details are sequentially arranged from the upper left to the lower right in ascending order of frequency, the raster scan order may be generally used for sequential scanning from the upper left to the lower right. In this application, levels of details in the displacement coefficient information are sequentially arranged from the lower right to the upper left in ascending order of frequency. Correspondingly, when traversal scanning is performed, the reverse scan order of the raster scan order may be selected for sequential scanning from the lower right to the upper left.

For example, in this embodiment of this application, FIG. 14 is a schematic diagram of a raster scan order. As shown in FIG. 14, if levels of details are sequentially arranged from the upper left to the lower right in ascending order of frequency, an LOD1, an LOD2, and an LOD3 may be sequentially traversed based on the raster scan order from the upper left to the lower right.

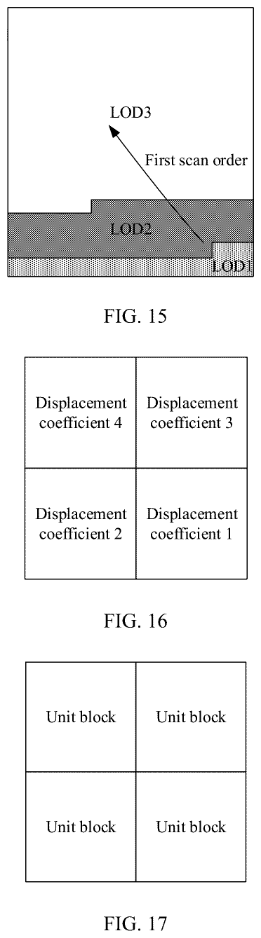

For example, in this embodiment of this application, FIG. 15 is a schematic diagram of a first scan order. As shown in FIG. 15, if levels of details are sequentially arranged from the lower right to the upper left in ascending order of frequency, an LOD1, an LOD2, and an LOD3 may be sequentially traversed based on the first scan order from the lower right to the upper left.

It may be understood that in this embodiment of this application, each level of details includes at least one coefficient block. Therefore, the at least one coefficient block may be determined after all levels of details in the displacement coefficient information are traversed based on the first scan order.

It may be understood that in this embodiment of this application, the coefficient block may be a square block including at least one unit block. Each unit block may include 2×2 displacement coefficients.

For example, in this embodiment of this application, FIG. 16 is a schematic diagram of a unit block. As shown in FIG. 16, each unit block may include four displacement coefficients, for example, displacement coefficients 1 to 4. The four displacement coefficients are arranged in a form of two rows and two columns to form a square unit block.

Further, in this embodiment of this application, the displacement coefficients in the unit block may be arranged in ascending order of frequency, where a high-frequency displacement coefficient is located on a left side and/or an upper side of a low-frequency displacement coefficient.

For example, in this embodiment of this application, as shown in FIG. 16, in the four displacement coefficients in the unit block, the displacement coefficients 1 to 4 are sequentially arranged from low frequency to high frequency. Therefore, the displacement coefficient 1 is located in a lower right corner, and the displacement coefficient 4 is located in an upper left corner.

It should be noted that in this embodiment of this application, a size of a coefficient block may be any integer multiple of a unit block. This application sets no specific limitation.

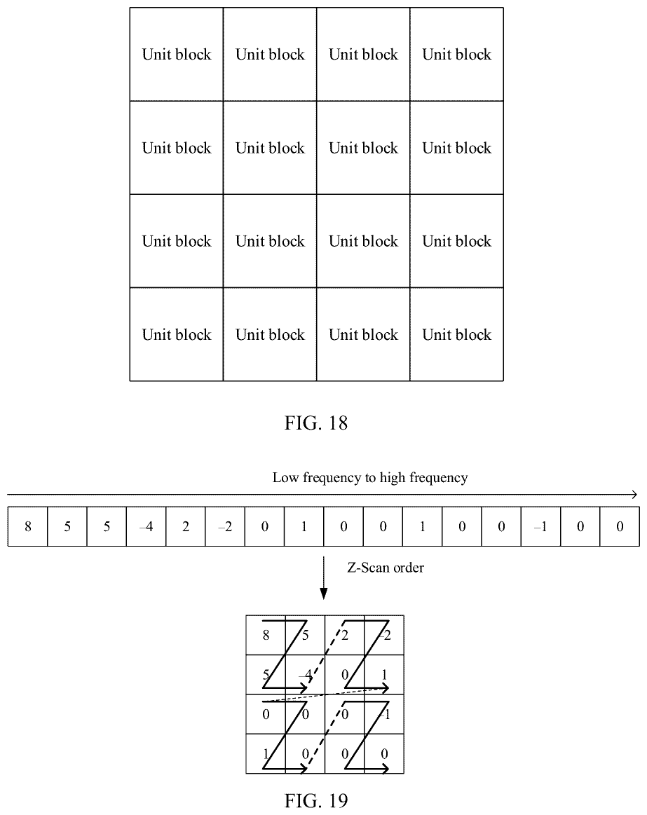

For example, in this embodiment of this application, FIG. 17 is a first schematic diagram of a coefficient block, and FIG. 18 is a second schematic diagram of a coefficient block. As shown in FIG. 17 and FIG. 18, a size of a coefficient block may be 16×16 and includes four unit blocks, or may be 32×32 and includes 16 unit blocks.
Step 103: Determine a plurality of displacement coefficients based on the at least one coefficient block and a second scan order.

In this embodiment of this application, after the at least one coefficient block is determined from the displacement coefficient information based on the first scan order, the decoder may further determine the plurality of displacement coefficients based on the at least one coefficient block and the second scan order.

Further, in this embodiment of this application, based on an arrangement order of displacement coefficients in a coefficient block, the decoder may sequentially traverse a low-frequency displacement coefficient and a high-frequency displacement coefficient in the coefficient block based on the second scan order.

It should be noted that in this embodiment of this application, the second scan order may be a reverse scan order of a Z-scan order. Z in Z-scan (Z-Scan) is a visual representation manner. The Z-Scan order ensures that addressing can be performed in a same traversal order for different partitions, which is conducive to recursive implementation in a program.

It should be noted that in this embodiment of this application, when unit blocks formed by displacement coefficients are sequentially arranged from the upper left to the lower right in ascending order of frequency, the Z-Scan order may be generally used for sequential scanning from the upper left to the lower right. In this application, displacement coefficients of unit blocks in a coefficient block are sequentially arranged from the lower right to the upper left in ascending order of frequency. Correspondingly, when traversal scanning is performed, the reverse scan order of the Z-scan order may be selected for sequential scanning from the lower right to the upper left.

For example, in this embodiment of this application, FIG. 19 is a schematic diagram of a Z-scan order. As shown in FIG. 19, if unit blocks formed by displacement coefficients are sequentially arranged from the upper left to the lower right in ascending order of frequency, unit blocks and displacement coefficients in each unit block may be sequentially traversed based on the Z-scan order from the upper left to the lower right. That is, unit blocks in a coefficient block are scanned based on the Z-scan order, and displacement coefficients in each unit block are also scanned based on the Z-scan order.

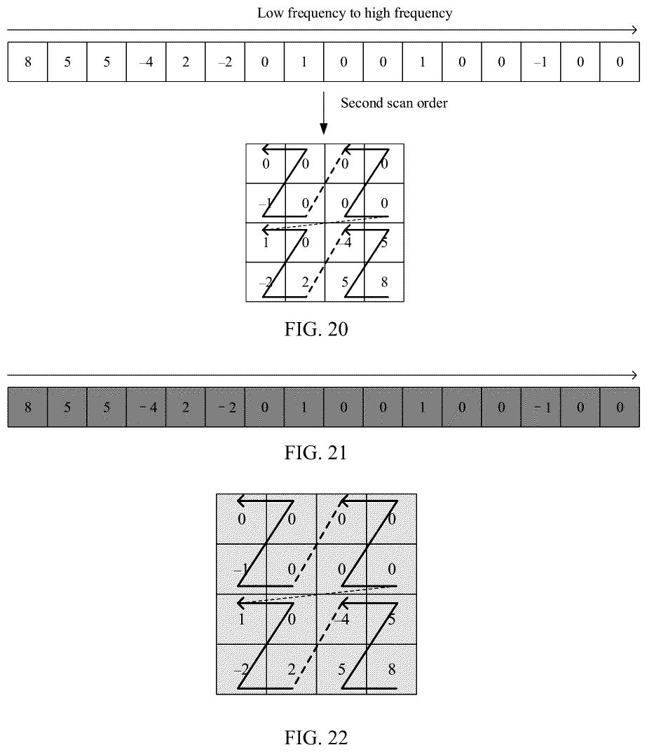

For example, in this embodiment of this application, FIG. 20 is a schematic diagram of a second scan order. As shown in FIG. 20, if unit blocks formed by displacement coefficients are sequentially arranged from the lower right to the upper left in ascending order of frequency, unit blocks and displacement coefficients in each unit block may be sequentially traversed based on the second scan order from the lower right to the upper left. That is, unit blocks in a coefficient block are scanned based on the second scan order, and displacement coefficients in each unit block are also scanned based on the second scan order.

It may be understood that in this embodiment of this application, because a unit block in each coefficient block includes at least one displacement coefficient (for example, four displacement coefficients), the plurality of displacement coefficients may be determined after all unit blocks in the coefficient block are traversed based on the second scan order.
Step 104: Determine a reconstructed original mesh of the current frame based on the plurality of displacement coefficients and a decimated mesh of the current frame.

In this embodiment of this application, after the plurality of displacement coefficients are determined based on the at least one coefficient block and the second scan order, the decoder may further determine the reconstructed original mesh of the current frame based on the plurality of displacement coefficients and the decimated mesh of the current frame.

Further, in this embodiment of this application, after the plurality of displacement coefficients corresponding to the current frame are determined, a plurality of displacement vectors may be further determined based on the plurality of displacement coefficients. Then, reconstruction of geometric information may be performed based on the plurality of displacement vectors and the decimated mesh, to determine the reconstructed original mesh of the current frame.

It should be noted that in this embodiment of this application, because a displacement coefficient is generated by performing wavelet transform on a displacement vector, inverse wavelet transform processing may be separately performed on the plurality of displacement coefficients, to determine the plurality of displacement vectors.

It should be noted that in this embodiment of this application, in performing the reconstruction of the geometric information based on the plurality of displacement vectors and the decimated mesh of the current frame, subdivision processing may be first performed on the decimated mesh to determine a subdivided mesh of the current frame. Then, the reconstructed original mesh may be determined based on the plurality of displacement vectors and the subdivided mesh.

It may be understood that in this embodiment of this application, a displacement vector is obtained based on the original mesh and the subdivided mesh of the current frame. Therefore, after the displacement vector and the subdivided mesh are determined, the geometric information may be further reconstructed based on the displacement vector and the subdivided mesh to obtain the reconstructed original mesh corresponding to the current frame.

Further, in this embodiment of this application, the decimated mesh of the current frame may be obtained by using a mesh decoder. The mesh decoder decodes the bitstream, so that the decimated mesh corresponding to the current frame can be directly or indirectly determined.

It may be understood that in this embodiment of this application, the coding method provided in this application may be applied to both intra coding and inter coding. This application sets no specific limitation.

It should be noted that in this embodiment of this application, for intra coding, the mesh decoder may decode the bitstream to obtain the corresponding decimated mesh of the current frame.

Correspondingly, in this embodiment of this application, for intra coding, the mesh decoder may receive a bitstream of the decimated mesh transmitted by an encoding side, and determine the decimated mesh of the current frame by decoding the bitstream of the decimated mesh.

It should be noted that in this embodiment of this application, for inter coding, the mesh decoder may decode the bitstream to obtain a corresponding motion vector of the current frame, and then further determine the decimated mesh of the current frame based on the motion vector.

Correspondingly, in this embodiment of this application, for inter coding, the mesh decoder may receive a bitstream of the motion vector transmitted by an encoding side, then determine a motion vector of the current frame by decoding the bitstream of the motion vector, and further determine the decimated mesh of the current frame by using the motion vector of the current frame and a decimated mesh of a decoded previous frame (a reference frame).

In conclusion, through the decoding method provided in the foregoing step 101 to step 104, a method for organizing displacement coefficients is used in dynamic mesh coding. An order of organizing wavelet-transformed displacement coefficients is changed, and the displacement coefficients are organized by using an inverse Z-scan order and an inverse raster scan order, thereby reducing a bit rate required for lossless encoding of a displacement coefficient.

It should be noted that, to demonstrate beneficial effects of the coding method provided in embodiments of this application in actual application, a method for organizing displacement coefficients provided in embodiments of this application is tested with an MPEG test sequence, and is compared with the method used in the standard reference software. A comparison result is shown in Table 1, and a test result of this solution with the MPEG test sequence is shown in Table 1. AI and RA in the table respectively represent an all intra (All Intra) encoding mode and a random access (Random Access) encoding mode. R1 to R5 are five bit rate points specified in an MPEG universal test condition. It can be learned from Table 1 that, compared with the method for organizing displacement coefficients used in the standard reference software, through the method for organizing displacement coefficients provided in embodiments of this application, a bit rate required for encoding a displacement coefficient is reduced for each of R1 to R3, and is slightly increased for R4 and R5. In addition, the solution of the present invention does not increase coding complexity, and therefore has practical value.

TABLE 1

| Mode | AI | | | | |
|---|---|---|---|---|---|
| Bit rate point | R1 | R2 | R3 | R4 | R5 |
| Bit rate | 97.9% | 98.01% | 99.22% | 100.07% | 100.04% |
| ratio | | | | | |
| Mode | RA | | | | |
| Bit rate point | R1 | R2 | R3 | R4 | R5 |
| Bit rate | 98.95% | 98.49% | 99.14% | 100.34% | 100.43% |
| ratio | | | | | |

An embodiment of this application provides a decoding method. At a decoding side, a decoder decodes a bitstream to determine displacement coefficient information of a current frame; determines at least one coefficient block from the displacement coefficient information based on a first scan order; determine a plurality of displacement coefficients based on the at least one coefficient block and a second scan order; and determines a reconstructed original mesh of the current frame based on the plurality of displacement coefficients and a decimated mesh of the current frame. It can be learned that, in embodiments of this application, in compressing geometric information of a mesh in coding, displacement coefficients may be traversed based on the first scan order to determine coefficient blocks, and the coefficient blocks may be traversed based on the second scan order to determine the displacement coefficient information. In the displacement coefficient information of the current frame obtained based on the first scan order and the second scan order, high-frequency information is located on an upper left side of the frame, and low-frequency information is located on a lower right side of the frame, so that the high-frequency information with low complexity can be first processed, and can be used as a reference during subsequent processing of the low-frequency information with high complexity. In other words, in embodiments of this application, a better strategy for organizing displacement coefficients is used to reduce a bit rate for encoding a displacement coefficient, thereby improving mesh compression performance.

Based on the foregoing embodiment, still another embodiment of this application provides a decoding method. The decoding method is applied to a decoder, and the decoder may include a video decoder and a mesh decoder.

It should be noted that in this embodiment of this application, the decoding method may be used for both intra decoding and inter decoding. This application sets no specific limitation.

Further, in this embodiment of this application, the mesh decoder may be configured to decode a bitstream to determine a decimated mesh of a current frame. During intra decoding, a bitstream transmitted to the mesh decoder may be a bitstream of the decimated mesh. In this case, the mesh decoder may decode the bitstream to obtain the corresponding decimated mesh of the current frame. During inter decoding, a bitstream transmitted to the mesh decoder may be a bitstream of a motion vector. In this case, the mesh decoder may decode the bitstream to determine a motion vector of the current frame, and may further determine the decimated mesh of the current frame by using the motion vector of the current frame and a decimated mesh of a decoded previous frame (a reference frame).

It should be noted that in this embodiment of this application, after the decimated mesh of the current frame is determined by using the mesh decoder, the video decoder may further complete reconstruction of an original mesh of the current frame by using the decimated mesh. The video decoder may first decode the bitstream to determine displacement coefficient information of the current frame; determine at least one coefficient block from the displacement coefficient information based on a first scan order; determine a plurality of displacement coefficients based on the at least one coefficient block and a second scan order; and determine a reconstructed original mesh of the current frame based on the plurality of displacement coefficients and a decimated mesh of the current frame.

It may be understood that in this embodiment of this application, the first scan order includes a reverse scan order of a raster scan order. The second scan order includes a reverse scan order of a Z-scan order.

Further, in this embodiment of this application, the decoder may determine a plurality of displacement vectors based on the plurality of displacement coefficients; and then determine the reconstructed original mesh based on the plurality of displacement vectors and the decimated mesh. The decoder may perform inverse wavelet transform processing on the plurality of displacement coefficients to determine the plurality of displacement vectors.

It may be understood that in this embodiment of this application, the decoder may first perform subdivision processing on the decimated mesh to determine a subdivided mesh of the current frame; and then determine the reconstructed original mesh based on the plurality of displacement vectors and the subdivided mesh.

It should be noted that in this embodiment of this application, the coefficient block is a square block including at least one unit block, where the unit block includes 2×2 displacement coefficients. The displacement coefficients in the unit block are arranged in ascending order of frequency, where a high-frequency displacement coefficient is located on a left side and/or an upper side of a low-frequency displacement coefficient.

It should be noted that in this embodiment of this application, the displacement coefficient information includes at least one LOD including the at least one coefficient block. The at least one LOD is arranged in ascending order of frequency, where an LOD including high-frequency information is located on a left side and/or an upper side of an LOD including low-frequency information.

Further, in this embodiment of this application, if a quantity of rows of the displacement coefficient information is less than a preset height threshold, video padding is performed on the displacement coefficient information based on a preset value and the preset height threshold, where the first position includes a position above a last LOD in the displacement coefficient information.

Further, in this embodiment of this application, if there is a vacant part in a last row in the displacement coefficient information, frame padding is performed on the displacement coefficient information based on a second position and the preset value, where the second position includes a position on an upper left side of a last LOD in the displacement coefficient information.

It can be learned that the coding method provided in embodiments of this application may be a method for organizing displacement coefficients in dynamic mesh coding. An order of organizing wavelet-transformed displacement vectors (displacement coefficients) in standard reference software is changed, thereby reducing a bit rate required for lossless encoding of a displacement vector (displacement coefficient).

It may be understood that in this embodiment of this application, in organizing displacement coefficients, wavelet-transformed displacement vectors (displacement coefficients) may be traversed in ascending order of frequency, and the displacement vectors (displacement coefficients) are organized into a 16×16 square block (coefficient block) based on a reverse Z-scan order (the second scan order). Then, organized square blocks may be spliced based on a reverse raster scan order (the first scan order, that is, from the lower right to the upper left). Finally, for a vacant part in an uppermost row, a constant 512 (the preset value) is used for padding to form a rectangular video frame. In addition, if a quantity of rows of a current video frame is less than a maximum quantity (the preset height threshold) of rows of all video frames in the sequence, the vacant part is padded by using the constant 512 (the preset value).

For example, in this embodiment of this application, FIG. 21 is a schematic diagram of displacement coefficients, and FIG. 22 is a first schematic diagram of organizing displacement coefficients. As shown in FIG. 21 and FIG. 22, a reverse Z-scan method may be used in a coefficient block. In FIG. 21, the displacement coefficients are traversed in an order from a low-frequency coefficient to a high-frequency coefficient. In FIG. 22, the displacement coefficients are organized based on a reverse Z-scan order in a 16×16 block (a unit block is 4×4).

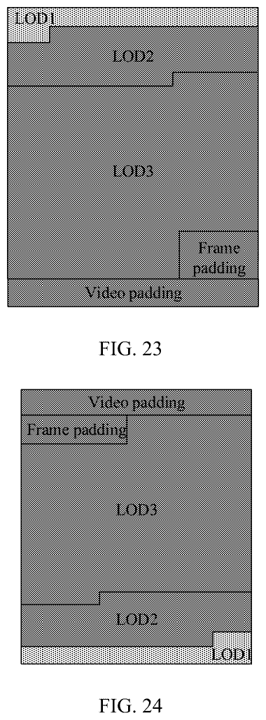

For example, in this embodiment of this application, FIG. 23 is a second schematic diagram of organizing displacement coefficients, and FIG. 24 is a third schematic diagram of organizing displacement coefficients. As shown in FIG. 23 and FIG. 24, LODs (Level of Details) 1 to 3 are respectively displacement coefficients including different frequency information. The LOD1 includes lowest-frequency information, and the LOD3 includes highest-frequency information. It can be learned that the part including the low-frequency information is more complex, and the part including the high-frequency information is simpler.

Currently, a common method used in the standard reference software is shown in FIG. 23. A raster scan order is used, that is, starting from an upper left corner, displacement coefficients are organized from the upper left to the lower right in ascending order of frequency. However, in this embodiment of this application, a reverse raster scan order is used, that is, starting from a lower right corner, displacement coefficients are organized from the lower right to the upper left in ascending order of frequency.

Because square blocks included in the LODs 1 to 3 do not necessarily form a rectangular video frame, a vacant part needs to be padded. Correspondingly, during frame padding (Frame Padding), as shown in FIG. 23, a vacant part in the lower right corner is padded in the standard reference software, and a vacant part in the upper left corner is padded in this embodiment of this application.

For a mesh sequence, because quantities of displacement coefficients of all frames are not necessarily equal, heights of video frames formed after the displacement coefficients are organized are not necessarily equal (in the standard reference software, a width of a video frame of displacement coefficients is a fixed constant). Therefore, a video frame with a smaller height needs to be padded, to ensure that a height of each video frame of displacement coefficients is constant. Correspondingly, during video padding (Video Padding), as shown in FIG. 23, a video frame is padded at the bottom in the standard reference software, and a video frame is padded at the top in this embodiment of this application.

An embodiment of this application provides a decoding method. At a decoding side, a decoder decodes a bitstream to determine displacement coefficient information of a current frame; determines at least one coefficient block from the displacement coefficient information based on a first scan order; determine a plurality of displacement coefficients based on the at least one coefficient block and a second scan order; and determines a reconstructed original mesh of the current frame based on the plurality of displacement coefficients and a decimated mesh of the current frame. It can be learned that, in embodiments of this application, in compressing geometric information of a mesh in coding, displacement coefficients may be traversed based on the first scan order to determine coefficient blocks, and the coefficient blocks may be traversed based on the second scan order to determine the displacement coefficient information. In the displacement coefficient information of the current frame obtained based on the first scan order and the second scan order, high-frequency information is located on an upper left side of the frame, and low-frequency information is located on a lower right side of the frame, so that the high-frequency information with low complexity can be first processed, and can be used as a reference during subsequent processing of the low-frequency information with high complexity. In other words, in embodiments of this application, a better strategy for organizing displacement coefficients is used to reduce a bit rate for encoding a displacement coefficient, thereby improving mesh compression performance.

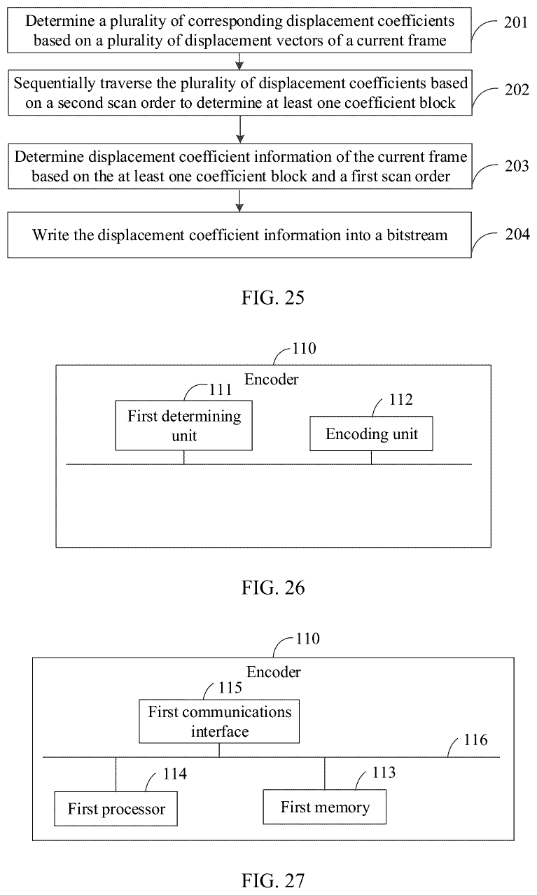

An embodiment of this application provides an encoding method. FIG. 25 is a schematic diagram of an encoding method according to an embodiment of this application. As shown in FIG. 25, in this embodiment of this application, encoding processing performed by an encoder may include the following steps:
Step 201: Determine a plurality of displacement coefficients based on a plurality of displacement vectors of a current frame.

In this embodiment of this application, the encoder may first determine the plurality of corresponding displacement coefficients of the current frame based on the plurality of displacement vectors of the current frame.

It should be noted that in this embodiment of this application, the encoder may be a video encoder, or may be any encoding apparatus including a video encoder and a mesh encoder.

It may be understood that in this embodiment of this application, the current frame may be a current image frame or a current video frame. This application sets no specific limitation.

Further, in this embodiment of this application, in determining a corresponding displacement coefficient by using a displacement vector, the encoder may separately perform wavelet transform processing on the plurality of displacement vectors, to determine the plurality of displacement coefficients.

It should be noted that in this embodiment of this application, the displacement vector may be determined by using a subdivided mesh of the current frame and an original mesh of the current frame. Decimation processing is performed on the original mesh to determine a decimated mesh, and subdivision processing is performed on the decimated mesh to determine the subdivided mesh.

It may be understood that in this embodiment of this application, in a preprocessing process, the original mesh (Original Mesh) of the current frame may be first decimated to obtain the decimated mesh (Decimated Mesh), which is referred to as a base mesh (Base Mesh). Then the decimated mesh may be subdivided to obtain the subdivided mesh (Subdivided Mesh). Finally, for each vertex in the subdivided mesh, a point closest to the vertex in the original mesh is found, and a displacement vector (Displacement) of the two points is calculated.

Further, in this embodiment of this application, the coding method provided in this application may be applied to both intra coding and inter coding. This application sets no specific limitation.

It should be noted that in this embodiment of this application, for intra coding, the mesh encoder may encode the decimated mesh of the current frame to obtain a bitstream of the decimated mesh.

Correspondingly, in this embodiment of this application, for intra coding, the video encoder may first determine a reconstructed decimated mesh of the current frame by using the generated bitstream of the decimated mesh; and then perform update processing on the displacement vector by using the reconstructed decimated mesh.

In other words, in this embodiment of this application, after the mesh encoder completes encoding of the decimated mesh of the current frame to generate the bitstream of the decimated mesh, the video encoder may complete the reconstruction of the decimated mesh by using the bitstream of the decimated mesh, and complete the update of the displacement vector by using the reconstructed decimated mesh.

It should be noted that in this embodiment of this application, for inter coding, the mesh encoder may encode a motion vector of the current frame to obtain a bitstream of the motion vector.

Correspondingly, in this embodiment of this application, for inter coding, the video encoder may first determine the motion vector of the current frame by using the generated bitstream of the motion vector, and then further determine a reconstructed decimated mesh of the current frame based on the motion vector; and finally perform update processing on the displacement vector by using the reconstructed decimated mesh.

In other words, in this embodiment of this application, after the mesh encoder completes encoding of the motion vector of the current frame to generate the bitstream of the motion vector, the video encoder may complete the reconstruction of the decimated mesh by using the bitstream of the motion vector, and complete the update of the displacement vector by using the reconstructed decimated mesh.

It may be understood that in this embodiment of this application, the encoder may further determine the reconstructed decimated mesh of the current frame by using the motion vector of the current frame and a reconstructed decimated mesh of a previous frame (a reference frame).
Step 202: Sequentially traverse the plurality of displacement coefficients based on a second scan order to determine at least one coefficient block.

In this embodiment of this application, after determining the plurality of corresponding displacement coefficients based on the plurality of displacement vectors of the current frame, the encoder may further sequentially traverse the plurality of displacement coefficients based on the second scan order to determine the at least one coefficient block.

It may be understood that in this embodiment of this application, the coefficient block may be a square block including at least one unit block. Each unit block may include 2×2 displacement coefficients.

For example, in this embodiment of this application, as shown in FIG. 16, each unit block may include four displacement coefficients, for example, displacement coefficients 1 to 4. The four displacement coefficients are arranged in a form of two rows and two columns to form a square unit block.

Further, in this embodiment of this application, the displacement coefficients in the unit block may be arranged in ascending order of frequency, where a high-frequency displacement coefficient is located on a left side and/or an upper side of a low-frequency displacement coefficient.

For example, in this embodiment of this application, as shown in FIG. 16, in the four displacement coefficients in the unit block, the displacement coefficients 1 to 4 are sequentially arranged from low frequency to high frequency. Therefore, the displacement coefficient 1 is located in a lower right corner, and the displacement coefficient 4 is located in an upper left corner.

It should be noted that in this embodiment of this application, a size of a coefficient block may be any integer multiple of a unit block. This application sets no specific limitation.

For example, in this embodiment of this application, as shown in FIG. 17 and FIG. 18, a size of a coefficient block may be 16×16 and includes four unit blocks, or may be 32×32 and includes 16 unit blocks.

Further, in this embodiment of this application, from a low-frequency displacement coefficient to a high-frequency displacement coefficient, the encoder may sequentially traverse the plurality of displacement coefficients of the current frame based on the second scan order, to obtain the at least one coefficient block of the current frame.

It should be noted that in this embodiment of this application, the second scan order may be a reverse scan order of a Z-scan order. Z in Z-scan (Z-Scan) is a visual representation manner. The Z-Scan order ensures that addressing can be performed in a same traversal order for different partitions, which is conducive to recursive implementation in a program.

It should be noted that in this embodiment of this application, when displacement coefficients are sequentially organized based on the Z-scan order from the upper left to the lower right in ascending order of frequency, unit blocks formed by the displacement coefficients may be sequentially arranged from the upper left to the lower right. In this application, displacement coefficients of unit blocks in a coefficient block are sequentially arranged from the lower right to the upper left in ascending order of frequency. Correspondingly, when the displacement coefficients are traversed, the reverse scan order of the Z-scan order may be selected to sequentially organize the displacement coefficients from the lower right to the upper left.

For example, in this embodiment of this application, as shown in FIG. 19, a plurality of displacement coefficients are traversed based on the Z-scan order in ascending order of frequency, and unit blocks formed by the displacement coefficients are sequentially arranged from the upper left to the lower right. That is, units block in a coefficient block are organized based on the Z-scan order, and displacement coefficients in each unit block are also organized based on the Z-scan order.

For example, in this embodiment of this application, as shown in FIG. 20, a plurality of displacement coefficients are traversed based on the second scan order in ascending order of frequency, and unit blocks formed by the displacement coefficients are sequentially arranged from the lower right to the upper left. That is, unit blocks in a coefficient block are organized based on the second scan order, and displacement coefficients in each unit block are also organized based on the second scan order.

It may be understood that in this embodiment of this application, because a unit block in each coefficient block includes at least one displacement coefficient (for example, four displacement coefficients), after the plurality of displacement coefficients of the current frame are traversed based on the second scan order, a unit block may be formed, and then a coefficient block may be formed.
Step 203: Determine displacement coefficient information of the current frame based on the at least one coefficient block and a first scan order.

In this embodiment of this application, after the plurality of displacement coefficients are sequentially traversed based on the second scan order to determine the at least one coefficient block, the encoder may further determine the displacement coefficient information of the current frame based on the at least one coefficient block and the first scan order.

It should be noted that in this embodiment of this application, the displacement coefficient information of the current frame may include at least one level of details LOD including the at least one coefficient block.

It may be understood that in this embodiment of this application, the at least one level of details in the displacement coefficient information may be arranged in ascending order of frequency. A level of details including high-frequency information is located on a left side and/or an upper side of a level of details including low-frequency information.

For example, in this embodiment of this application, as shown in FIG. 9, in displacement coefficient information including three levels of details (an LOD1, an LOD2, and an LOD3), the LOD1 includes lowest-frequency information, the LOD2 includes higher-frequency information, and the LOD3 includes highest-frequency information. The LOD1 including the lowest-frequency information is most complex, and the LOD3 including the highest-frequency information is most simple. The LOD3 including the highest-frequency information is located on an upper left side of the LOD1 including the lowest-frequency information.

It should be noted that in this embodiment of this application, the encoder may sequentially traverse the at least one coefficient block based on the first scan order in ascending order of frequency, and finally may generate displacement coefficient information of a level of details including low-frequency information and a level of details including high-frequency information.

It may be understood that in this embodiment of this application, the first scan order may be a reverse scan order of a raster scan order. Raster scan (RasterScan) refers to a process of scanning from left to right and top to bottom and moving to a start position of a next row to continue scanning after completing one row. The raster scan order is mainly used in a common coding procedure.

It should be noted that in this embodiment of this application, when the at least one coefficient block is sequentially traversed based on the raster scan order from the upper left to the lower right in ascending order of frequency, levels of details may be sequentially arranged from the upper left to the lower right. In this application, levels of details in the displacement coefficient information are sequentially arranged from the lower right to the upper left in ascending order of frequency. Correspondingly, when the at least one coefficient block is traversed and organized, the reverse scan order of the raster scan order may be selected to traverse the at least one coefficient block from the lower right to the upper left.

For example, in this embodiment of this application, as shown in FIG. 14, if an LOD1, an LOD2, and an LOD3 are sequentially organized based on the raster scan order from the upper left to the lower right in ascending order of frequency, levels of details may be sequentially arranged from the upper left to the lower right.

For example, in this embodiment of this application, as shown in FIG. 15, if an LOD1, an LOD2, and an LOD3 are sequentially organized based on the first scan order from the lower right to the upper left in ascending order of frequency, levels of details may be sequentially arranged from the lower right to the upper left.

It may be understood that in this embodiment of this application, each level of details includes at least one coefficient block. Therefore, the displacement coefficient information including the at least one level of details may be determined after the at least one coefficient block is traversed based on the first scan order.

Further, in this embodiment of this application, for the displacement coefficient information of the current frame generated by the encoder, if there is a vacant part in a last row in the displacement coefficient information, frame padding (Frame Padding) may be performed on the displacement coefficient information based on a second position and a preset value.

It may be understood that in this embodiment of this application, the preset value may be an integer greater than 0. For example, the preset value is 512.

For example, in this embodiment of this application, if there is a vacant part in the last row in the displacement coefficient information of the current frame, frame padding may be performed by using the constant 512, so that displacement coefficient information corresponding to each frame in a mesh sequence is rectangular, that is, it is ensured that the at least one LOD forms rectangular displacement coefficient information.

It may be understood that in this embodiment of this application, the second position may be a position on an upper left side of a last LOD in the displacement coefficient information. In this application, levels of details in the displacement coefficient information are sequentially arranged from the lower right to the upper left in ascending order of frequency. Therefore, during frame padding, padding processing may be performed on the upper left side of the last level of details including high-frequency information.

For example, in this embodiment of this application, as shown in FIG. 12, commonly, levels of details in the displacement coefficient information are sequentially arranged from the upper left to the lower right in ascending order of frequency. Therefore, during frame padding, a vacant part in a lower right corner of displacement coefficient information of a current frame may be padded.

For example, in this embodiment of this application, as shown in FIG. 13, in this application, levels of details in the displacement coefficient information are sequentially arranged from the lower right to the upper left in ascending order of frequency. Therefore, during frame padding, a vacant part in an upper left corner of displacement coefficient information of a current frame may be padded.

Further, in this embodiment of this application, for the displacement coefficient information of the current frame generated by the encoder, if a quantity of rows of the displacement coefficient information is less than a preset height threshold, video padding (Video Padding) may be performed on the displacement coefficient information based on a preset value and the preset height threshold.

It may be understood that in this embodiment of this application, the preset value may be an integer greater than 0. For example, the preset value is 512, and the preset height threshold may be a maximum height in a mesh sequence, that is, a height (a quantity of rows) corresponding to a frame with a largest quantity of displacement coefficients in the mesh sequence.

For example, in this embodiment of this application, if the quantity of rows of the displacement coefficient information of the current frame is less than the quantity of rows corresponding to the frame with the largest quantity of displacement coefficients in the mesh sequence, that is, is less than the preset height threshold, the constant 512 may be selected for video padding, so that heights (quantities of rows) of all frames in the mesh sequence are the same, that is, it is ensured that each frame in the mesh sequence has a constant height.

It should be noted that in this embodiment of this application, in standard reference software, a width of a video frame (or an image frame) of displacement coefficients may be a fixed constant. For a mesh sequence, because quantities of displacement coefficients of all frames are not necessarily equal, heights of video frames (or image frames) formed by different frames are not necessarily equal. Therefore, a video frame (or an image frame) with a smaller height needs to be padded, to ensure that a height of each video frame of displacement coefficients is constant.

It may be understood that in this embodiment of this application, a first position may be a position above a last LOD in the displacement coefficient information. In this application, levels of details in the displacement coefficient information are sequentially arranged from the lower right to the upper left in ascending order of frequency. Therefore, during video padding, padding processing may be performed above the last level of details including high-frequency information.

For example, in this embodiment of this application, as shown in FIG. 10, commonly, levels of details in the displacement coefficient information are sequentially arranged from the upper left to the lower right in ascending order of frequency. Therefore, during video padding, displacement coefficient information of a current frame may be padded at the bottom.

For example, in this embodiment of this application, as shown in FIG. 11, in this application, levels of details in the displacement coefficient information are sequentially arranged from the lower right to the upper left in ascending order of frequency. Therefore, during video padding, displacement coefficient information of a current frame may be padded at the top.
Step 204: Write the displacement coefficient information into a bitstream.

In this embodiment of this application, after the displacement coefficient information of the current frame is determined based on the at least one coefficient block and the first scan order, the encoder may further write the displacement coefficient information into the bitstream to generate the corresponding bitstream and transmit the corresponding bitstream to a decoding side.

It should be noted that in this embodiment of this application, a bitstream transmitted by the encoder to the decoder may be a bitstream of a displacement coefficient, or may be bitstream data including a bitstream of a displacement coefficient and a bitstream of a decimated mesh (or a bitstream of a motion vector).

In conclusion, through the decoding method provided in the foregoing step 201 to step 204, a method for organizing displacement coefficients is used in dynamic mesh coding. An order of organizing wavelet-transformed displacement coefficients is changed, and the displacement coefficients are organized by using an inverse Z-scan order and an inverse raster scan order, thereby reducing a bit rate required for lossless encoding of a displacement coefficient.

An embodiment of this application provides an encoding method. At an encoding side, an encoder determines a plurality of displacement coefficients based on a plurality of displacement vectors of a current frame; sequentially traverses the plurality of displacement coefficients based on a second scan order to determine at least one coefficient block; determines displacement coefficient information of the current frame based on the at least one coefficient block and a first scan order; and writes the displacement coefficient information into a bitstream. It can be learned that, in embodiments of this application, in compressing geometric information of a mesh in coding, displacement coefficients may be traversed based on the first scan order to determine coefficient blocks, and the coefficient blocks may be traversed based on the second scan order to determine the displacement coefficient information. In the displacement coefficient information of the current frame obtained based on the first scan order and the second scan order, high-frequency information is located on an upper left side of the frame, and low-frequency information is located on a lower right side of the frame, so that the high-frequency information with low complexity can be first processed, and can be used as a reference during subsequent processing of the low-frequency information with high complexity. In other words, in embodiments of this application, a better strategy for organizing displacement coefficients is used to reduce a bit rate for encoding a displacement coefficient, thereby improving mesh compression performance.

Based on the foregoing embodiment, still another embodiment of this application provides an encoding method. The encoding method is applied to an encoder, and the encoder includes a video encoder, a mesh encoder, and a preprocessor.

It should be noted that in this embodiment of this application, the encoding method may be used for both intra encoding and inter encoding. This application sets no specific limitation.

It should be noted that in this embodiment of this application, the preprocessor may be configured to generate a decimated mesh and a displacement vector based on an original mesh of a current frame.

It may be understood that in this embodiment of this application, in a preprocessing process, the original mesh (Original Mesh) of the current frame may be first decimated to obtain the decimated mesh (Decimated Mesh), which is referred to as a base mesh (Base Mesh). Then the decimated mesh may be subdivided to obtain the subdivided mesh (Subdivided Mesh). Finally, for each vertex in the subdivided mesh, a point closest to the vertex in the original mesh is found, and a displacement vector (Displacement) of the two points is calculated.

Further, in this embodiment of this application, after the preprocessor generates the corresponding decimated mesh based on the original mesh, the mesh encoder may be configured to encode the decimated mesh, and then generate a bitstream of the decimated mesh.

It should be noted that in this embodiment of this application, for intra encoding, the mesh encoder may encode the decimated mesh of the current frame to obtain the bitstream of the decimated mesh.

Correspondingly, in this embodiment of this application, for intra encoding, the video encoder may first determine a reconstructed decimated mesh of the current frame by using the generated bitstream of the decimated mesh; and then perform update processing on the displacement vector by using the reconstructed decimated mesh.

In other words, in this embodiment of this application, after the mesh encoder completes encoding of the decimated mesh of the current frame to generate the bitstream of the decimated mesh, the video encoder may complete the reconstruction of the decimated mesh by using the bitstream of the decimated mesh, and complete the update of the displacement vector by using the reconstructed decimated mesh.

It should be noted that in this embodiment of this application, for inter encoding, the mesh encoder may encode a motion vector of the current frame to obtain a bitstream of the motion vector.

Correspondingly, in this embodiment of this application, for inter encoding, the video encoder may first determine the motion vector of the current frame by using the generated bitstream of the motion vector, and then further determine a reconstructed decimated mesh of the current frame based on the motion vector; and finally perform update processing on the displacement vector by using the reconstructed decimated mesh.

In other words, in this embodiment of this application, after the mesh encoder completes encoding of the motion vector of the current frame to generate the bitstream of the motion vector, the video encoder may complete the reconstruction of the decimated mesh by using the bitstream of the motion vector, and complete the update of the displacement vector by using the reconstructed decimated mesh.

It may be understood that in this embodiment of this application, after generating the bitstream of the decimated mesh or the bitstream of the motion vector, the mesh encoder may transmit the bitstream of the decimated mesh or the bitstream of the motion vector to a decoding side.

Further, in this embodiment of this application, the video encoder may be configured to: determine a plurality of displacement coefficients based on a plurality of displacement vectors of a current frame; sequentially traverse the plurality of displacement coefficients based on a second scan order to determine at least one coefficient block; determine displacement coefficient information of the current frame based on the at least one coefficient block and a first scan order; and write the displacement coefficient information into a bitstream.

It should be noted that in this embodiment of this application, the encoder may perform wavelet transform processing on the plurality of displacement vectors, to determine the plurality of displacement coefficients.

It may be understood that in this embodiment of this application, the displacement vector is determined by using a subdivided mesh of the current frame and an original mesh of the current frame, where decimation processing is performed on the original mesh to determine a decimated mesh, and subdivision processing is performed on the decimated mesh to determine the subdivided mesh.

It may be understood that in this embodiment of this application, the first scan order includes a reverse scan order of a raster scan order. The second scan order includes a reverse scan order of a Z-scan order.

It should be noted that in this embodiment of this application, the coefficient block is a square block including at least one unit block, where the unit block includes 2×2 displacement coefficients. The displacement coefficients in the unit block are arranged in ascending order of frequency, where a high-frequency displacement coefficient is located on a left side and/or an upper side of a low-frequency displacement coefficient.

It should be noted that in this embodiment of this application, the displacement coefficient information includes at least one LOD including the at least one coefficient block. The at least one LOD is arranged in ascending order of frequency, where an LOD including high-frequency information is located on a left side and/or an upper side of an LOD including low-frequency information.

Further, in this embodiment of this application, if a quantity of rows of the displacement coefficient information is less than a preset height threshold, video padding is performed on the displacement coefficient information based on a preset value and the preset height threshold, where the first position includes a position above a last LOD in the displacement coefficient information.

Further, in this embodiment of this application, if there is a vacant part in a last row in the displacement coefficient information, frame padding is performed on the displacement coefficient information based on a second position and the preset value, where the second position includes a position on an upper left side of a last LOD in the displacement coefficient information.

It can be learned that the coding method provided in embodiments of this application may be a method for organizing displacement coefficients in dynamic mesh coding. An order of organizing wavelet-transformed displacement vectors (displacement coefficients) in standard reference software is changed, thereby reducing a bit rate required for lossless encoding of a displacement vector (displacement coefficient).

It may be understood that in this embodiment of this application, in organizing displacement coefficients, wavelet-transformed displacement vectors (displacement coefficients) may be traversed in ascending order of frequency, and the displacement vectors (displacement coefficients) are organized into a 16×16 square block (coefficient block) based on a reverse Z-scan order (the second scan order). Then, organized square blocks may be spliced based on a reverse raster scan order (the first scan order, that is, from the lower right to the upper left). Finally, for a vacant part in an uppermost row, a constant 512 (the preset value) is used for padding to form a rectangular video frame. In addition, if a quantity of rows of a current video frame is less than a maximum quantity (the preset height threshold) of rows of all video frames in the sequence, the vacant part is padded by using the constant 512 (the preset value).

For example, in this embodiment of this application, as shown in FIG. 21 and FIG. 22, a reverse Z-scan method may be used in a coefficient block. In FIG. 21, the displacement coefficients are traversed in an order from a low-frequency coefficient to a high-frequency coefficient. In FIG. 22, the displacement coefficients are organized based on a reverse Z-scan order in a 16×16 block (a unit block is 4×4).

For example, in this embodiment of this application, as shown in FIG. 23 and FIG. 24, LODs (Level of Details) 1 to 3 are respectively displacement coefficients including different frequency information. The LOD1 includes lowest-frequency information, and the LOD3 includes highest-frequency information. It can be learned that the part including the low-frequency information is more complex, and the part including the high-frequency information is simpler.

Currently, a common method used in the standard reference software is shown in FIG. 23. A raster scan order is used, that is, starting from an upper left corner, displacement coefficients are organized from the upper left to the lower right in ascending order of frequency. However, in this embodiment of this application, a reverse raster scan order is used, that is, starting from a lower right corner, displacement coefficients are organized from the lower right to the upper left in ascending order of frequency.

Because square blocks included in the LODs 1 to 3 do not necessarily form a rectangular video frame, a vacant part needs to be padded. Correspondingly, during frame padding (Frame Padding), as shown in FIG. 23, a vacant part in the lower right corner is padded in the standard reference software, and a vacant part in the upper left corner is padded in this embodiment of this application.

For a mesh sequence, because quantities of displacement coefficients of all frames are not necessarily equal, heights of video frames formed after the displacement coefficients are organized are not necessarily equal (in the standard reference software, a width of a video frame of displacement coefficients is a fixed constant). Therefore, a video frame with a smaller height needs to be padded, to ensure that a height of each video frame of displacement coefficients is constant. Correspondingly, during video padding (Video Padding), as shown in FIG. 23, a video frame is padded at the bottom in the standard reference software, and a video frame is padded at the top in this embodiment of this application.

An embodiment of this application provides an encoding method. At an encoding side, an encoder determines a plurality of displacement coefficients based on a plurality of displacement vectors of a current frame; sequentially traverses the plurality of displacement coefficients based on a second scan order to determine at least one coefficient block; determines displacement coefficient information of the current frame based on the at least one coefficient block and a first scan order; and writes the displacement coefficient information into a bitstream. It can be learned that, in embodiments of this application, in compressing geometric information of a mesh in coding, displacement coefficients may be traversed based on the first scan order to determine coefficient blocks, and the coefficient blocks may be traversed based on the second scan order to determine the displacement coefficient information. In the displacement coefficient information of the current frame obtained based on the first scan order and the second scan order, high-frequency information is located on an upper left side of the frame, and low-frequency information is located on a lower right side of the frame, so that the high-frequency information with low complexity can be first processed, and can be used as a reference during subsequent processing of the low-frequency information with high complexity. In other words, in embodiments of this application, a better strategy for organizing displacement coefficients is used to reduce a bit rate for encoding a displacement coefficient, thereby improving mesh compression performance.

Based on the foregoing embodiment, in still another embodiment of this application, based on a same inventive concept of the foregoing embodiment, FIG. 26 is a first schematic structural diagram of an encoder. As shown in FIG. 26, an encoder 110 may include a first determining unit 111 and an encoding unit 112.

The first determining unit 111 is configured to: determine a plurality of displacement coefficients based on a plurality of displacement vectors of a current frame; sequentially traverse the plurality of displacement coefficients based on a second scan order to determine at least one coefficient block; and determine displacement coefficient information of the current frame based on the at least one coefficient block and a first scan order.

The encoding unit 112 is configured to write the displacement coefficient information into a bitstream.

It may be understood that in this embodiment, the “unit” may be a partial circuit, a partial processor, a partial program or software, or the like. Certainly, the “unit” may be a module or may be in a non-modular form. In addition, the components in this embodiment may be integrated into one processing unit, or each of the units may exist alone physically, or two or more units may be integrated into one unit. The foregoing integrated unit may be implemented in a form of hardware, or may be implemented in a form of a software functional module.

When the integrated unit is implemented in a form of a software functional module and not sold or used as an independent product, the integrated unit may be stored in a computer-readable storage medium. Based on such an understanding, the technical solutions of this embodiment essentially, or the part contributing to the prior art, or all or a part of the technical solutions may be implemented in a form of a software product. The computer software product is stored in a storage medium and includes several instructions for instructing a computer device (which may be a personal computer, a server, or a network device) or a processor (processor) to execute all or a part of the steps of the method described in this embodiment. The foregoing storage medium includes: any medium that can store program code, such as a USB flash drive, a removable hard disk, a read-only memory (Read Only Memory, ROM), a random access memory (Random Access Memory, RAM), a magnetic disk, or an optical disc.

Therefore, an embodiment of this application provides a computer-readable storage medium, applied to the encoder 110. The computer-readable storage medium stores a computer program, and the computer program is executed by a first processor to implement the method in any one of the foregoing embodiments.

Based on the foregoing structure of the encoder 110 and the computer-readable storage medium, FIG. 27 is a second schematic structural diagram of an encoder. As shown in FIG. 27, the encoder 110 may include a first memory 113, a first processor 114, a first communications interface 115, and a first bus system 116. The first memory 113, the first processor 114, and the first communications interface 115 are coupled through the first bus system 116. It may be understood that the first bus system 116 is configured to implement a connection and communication between these components. The first bus system 116 further includes a power bus, a control bus, a status signal bus, and the like, in addition to a data bus. However, for clarity of description, various buses are marked as the first bus system 116 in FIG. 10.

The first communications interface 115 is configured to receive and transmit a signal in a process of transmitting and receiving information between the first communications interface and another external network element.

The first memory 113 is configured to store a computer program runnable by the first processor.

The first processor 114 is configured to: when running the computer program, determine a plurality of displacement coefficients based on a plurality of displacement vectors of a current frame; sequentially traverse the plurality of displacement coefficients based on a second scan order to determine at least one coefficient block; determine displacement coefficient information of the current frame based on the at least one coefficient block and a first scan order; and write the displacement coefficient information into a bitstream.

It may be understood that the first memory 113 in this embodiment of this application may be a volatile memory or a nonvolatile memory, or may include a volatile memory and a nonvolatile memory. The nonvolatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM) and used as an external cache. By way of example but not limitation, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous link dynamic random access memory (Synchlink DRAM, SLDRAM), and a direct rambus dynamic random access memory (Direct Rambus RAM, DRRAM). The first memory 113 in the system and the method described in this application is to include but is not limited to these memories and a memory of any other proper type.

The first processor 114 may be an integrated circuit chip and has a signal processing capability. In an implementation process, the steps of the foregoing methods may be completed by using an integrated logic circuit of hardware in the first processor 114 or an instruction in a form of software. The first processor 114 may be a general purpose processor, a digital signal processor (Digital Signal Processor, DSP), an application specific integrated circuit (Application Specific Integrated Circuit, ASIC), a field programmable gate array (Field Programmable Gate Array, FPGA) or another programmable logical device, a discrete gate or transistor logic device, or a discrete hardware component. The first processor may implement or execute the methods, the steps, and logical block diagrams that are disclosed in embodiments of this application. The general-purpose processor may be a microprocessor, or the processor may be any conventional processor or the like. The steps of the methods disclosed with reference to embodiments of this application may be directly executed and completed through a hardware decoding processor, or may be executed and completed by using a combination of hardware and software modules in the decoding processor. The software module may be located in a mature storage medium in the art, such as a random access memory, a flash memory, a read-only memory, a programmable read-only memory, an electrically erasable programmable memory, or a register. The storage medium is located in the first memory 113. The first processor 114 reads information from the first memory 113, and completes the steps of the foregoing methods in combination with hardware thereof.

It may be understood that these embodiments described in this application may be implemented by hardware, software, firmware, middleware, microcode, or a combination thereof. For hardware implementation, a processing unit may be implemented in one or more application specific integrated circuits (Application Specific Integrated Circuits, ASIC), digital signal processors (Digital Signal Processing, DSP), digital signal processing devices (DSP Device, DSPD), programmable logic devices (Programmable Logic Device, PLD), field-programmable gate arrays (Field-Programmable Gate Array, FPGA), general-purpose processors, controllers, microcontrollers, microprocessors, or other electronic units or a combination thereof used to execute the functions described in this application. For software implementation, the technology described in this application may be implemented by using a module (for example, a process or a function) that executes the function in this application. Software code may be stored in a memory and executed by a processor. The memory may be implemented in the processor or outside the processor.

Optionally, in another embodiment, the first processor 114 is further configured to: when running the computer program, execute the method in any one of the foregoing embodiments.

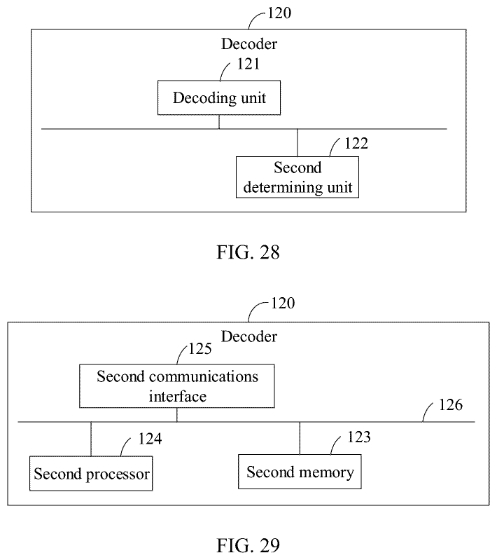

FIG. 28 is a first schematic structural diagram of a decoder. As shown in FIG. 28, a decoder 120 may include a decoding unit 121 and a second determining unit 122.

The decoding unit 121 is configured to decode a bitstream.

The second determining unit 122 is configured to: determine displacement coefficient information of a current frame; determine at least one coefficient block from the displacement coefficient information based on a first scan order; determine a plurality of displacement coefficients based on the at least one coefficient block and a second scan order; and determine a reconstructed original mesh of the current frame based on the plurality of displacement coefficients and a decimated mesh of the current frame.

It may be understood that in this embodiment, the “unit” may be a partial circuit, a partial processor, a partial program or software, or the like. Certainly, the “unit” may be a module or may be in a non-modular form. In addition, the components in this embodiment may be integrated into one processing unit, or each of the units may exist alone physically, or two or more units may be integrated into one unit. The foregoing integrated unit may be implemented in a form of hardware, or may be implemented in a form of a software functional module.

When the integrated unit is implemented in a form of a software functional module and not sold or used as an independent product, the integrated unit may be stored in a computer-readable storage medium. Based on such an understanding, the technical solutions of this embodiment essentially, or the part contributing to the prior art, or all or a part of the technical solutions may be implemented in a form of a software product. The computer software product is stored in a storage medium and includes several instructions for instructing a computer device (which may be a personal computer, a server, or a network device) or a processor (processor) to execute all or a part of the steps of the method described in this embodiment. The foregoing storage medium includes: any medium that can store program code, such as a USB flash drive, a removable hard disk, a read-only memory (Read Only Memory, ROM), a random access memory (Random Access Memory, RAM), a magnetic disk, or an optical disc.

Therefore, an embodiment of this application provides a computer-readable storage medium, applied to the decoder 120. The computer-readable storage medium stores a computer program, and the computer program is executed by a first processor to implement the method in any one of the foregoing embodiments.

Based on the foregoing structure of the decoder 120 and the computer-readable storage medium, FIG. 29 is a second schematic structural diagram of a decoder. As shown in FIG. 29, the decoder 120 may include a second memory 123, a second processor 124, a second communications interface 125, and a second bus system 126. The second memory 123, the second processor 124, and the second communications interface 125 are coupled through the second bus system 126. It may be understood that the second bus system 126 is configured to implement a connection and communication between these components. The second bus system 126 further includes a power bus, a control bus, a status signal bus, and the like, in addition to a data bus. However, for clarity of description, various buses are marked as the second bus system 126 in FIG. 12.

The second communications interface 125 is configured to receive and transmit a signal in a process of transmitting and receiving information between the second communications interface and another external network element.

The second memory 123 is configured to store a computer program runnable by the second processor.

The second processor 124 is configured to: when running the computer program, decode a bitstream to determine displacement coefficient information of a current frame; determine at least one coefficient block from the displacement coefficient information based on a first scan order; determine a plurality of displacement coefficients based on the at least one coefficient block and a second scan order; and determine a reconstructed original mesh of the current frame based on the plurality of displacement coefficients and a decimated mesh of the current frame.

It may be understood that the second memory 123 in this embodiment of this application may be a volatile memory or a nonvolatile memory, or may include a volatile memory and a nonvolatile memory. The nonvolatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM) and used as an external cache. By way of example but not limitation, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous link dynamic random access memory (Synchlink DRAM, SLDRAM), and a direct rambus dynamic random access memory (Direct Rambus RAM, DRRAM). The second memory 123 in the system and the method described in this application is to include but is not limited to these memories and a memory of any other proper type.

The second processor 124 may be an integrated circuit chip and has a signal processing capability. In an implementation process, the steps of the foregoing methods may be completed by using an integrated logic circuit of hardware in the second processor 124 or an instruction in a form of software. The second processor 124 may be a general purpose processor, a digital signal processor (Digital Signal Processor, DSP), an application specific integrated circuit (Application Specific Integrated Circuit, ASIC), a field programmable gate array (Field Programmable Gate Array, FPGA) or another programmable logical device, a discrete gate or transistor logic device, or a discrete hardware component. The second processor may implement or execute the methods, the steps, and logical block diagrams that are disclosed in embodiments of this application. The general-purpose processor may be a microprocessor, or the processor may be any conventional processor or the like. The steps of the methods disclosed with reference to embodiments of this application may be directly executed and completed through a hardware decoding processor, or may be executed and completed by using a combination of hardware and software modules in the decoding processor. The software module may be located in a mature storage medium in the art, such as a random access memory, a flash memory, a read-only memory, a programmable read-only memory, an electrically erasable programmable memory, or a register. The storage medium is located in the second memory 123. The second processor 124 reads information from the second memory 123, and completes the steps of the foregoing methods in combination with hardware thereof.

It may be understood that these embodiments described in this application may be implemented by hardware, software, firmware, middleware, microcode, or a combination thereof. For hardware implementation, a processing unit may be implemented in one or more application specific integrated circuits (Application Specific Integrated Circuits, ASIC), digital signal processors (Digital Signal Processing, DSP), digital signal processing devices (DSP Device, DSPD), programmable logic devices (Programmable Logic Device, PLD), field-programmable gate arrays (Field-Programmable Gate Array, FPGA), general-purpose processors, controllers, microcontrollers, microprocessors, or other electronic units or a combination thereof used to execute the functions described in this application. For software implementation, the technology described in this application may be implemented by using a module (for example, a process or a function) that executes the function in this application. Software code may be stored in a memory and executed by a processor. The memory may be implemented in the processor or outside the processor.

Embodiments of this application provide a coding method, an encoder, a decoder, and a storage medium. At a decoding side, a decoder decodes a bitstream to determine displacement coefficient information of a current frame; determines at least one coefficient block from the displacement coefficient information based on a first scan order; determine a plurality of displacement coefficients based on the at least one coefficient block and a second scan order; and determines a reconstructed original mesh of the current frame based on the plurality of displacement coefficients and a decimated mesh of the current frame. At an encoding side, an encoder determines a plurality of displacement coefficients based on a plurality of displacement vectors of a current frame; sequentially traverses the plurality of displacement coefficients based on a second scan order to determine at least one coefficient block; determines displacement coefficient information of the current frame based on the at least one coefficient block and a first scan order; and writes the displacement coefficient information into a bitstream. It can be learned that, in embodiments of this application, in compressing geometric information of a mesh in coding, displacement coefficients may be traversed based on the first scan order to determine coefficient blocks, and the coefficient blocks may be traversed based on the second scan order to determine the displacement coefficient information. In the displacement coefficient information of the current frame obtained based on the first scan order and the second scan order, high-frequency information is located on an upper left side of the frame, and low-frequency information is located on a lower right side of the frame, so that the high-frequency information with low complexity can be first processed, and can be used as a reference during subsequent processing of the low-frequency information with high complexity. In other words, in embodiments of this application, a better strategy for organizing displacement coefficients is used to reduce a bit rate for encoding a displacement coefficient, thereby improving mesh compression performance.

It should be noted that, in embodiments of this application, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element.

The sequence numbers of the foregoing embodiments of this application are merely for illustrative purposes, and are not intended to indicate priorities of the embodiments.

The methods disclosed in the several method embodiments provided in this application may be randomly combined without conflict to obtain a new method embodiment.

The features disclosed in the several product embodiments provided in this application may be randomly combined without conflict to obtain a new product embodiment.

The features disclosed in the several method or device embodiments provided in this application may be randomly combined without conflict to obtain a new method or device embodiment.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

### INDUSTRIAL APPLICABILITY

Embodiments of this application provide a coding method, an encoder, a decoder, and a storage medium. At a decoding side, a decoder decodes a bitstream to determine displacement coefficient information of a current frame; determines at least one coefficient block from the displacement coefficient information based on a first scan order; determine a plurality of displacement coefficients based on the at least one coefficient block and a second scan order; and determines a reconstructed original mesh of the current frame based on the plurality of displacement coefficients and a decimated mesh of the current frame. At an encoding side, an encoder determines a plurality of displacement coefficients based on a plurality of displacement vectors of a current frame; sequentially traverses the plurality of displacement coefficients based on a second scan order to determine at least one coefficient block; determines displacement coefficient information of the current frame based on the at least one coefficient block and a first scan order; and writes the displacement coefficient information into a bitstream. It can be learned that, in embodiments of this application, in compressing geometric information of a mesh in coding, displacement coefficients may be traversed based on the first scan order to determine coefficient blocks, and the coefficient blocks may be traversed based on the second scan order to determine the displacement coefficient information. In the displacement coefficient information of the current frame obtained based on the first scan order and the second scan order, high-frequency information is located on an upper left side of the frame, and low-frequency information is located on a lower right side of the frame, so that the high-frequency information with low complexity can be first processed, and can be used as a reference during subsequent processing of the low-frequency information with high complexity. In other words, in embodiments of this application, a better strategy for organizing displacement coefficients is used to reduce a bit rate for encoding a displacement coefficient, thereby improving mesh compression performance.

What is claimed is:

1. A decoding method, applied to a decoder, wherein the method comprises:
decoding a bitstream to determine displacement coefficient information of a current frame;
determining at least one coefficient block from the displacement coefficient information based on a first scan order;
determining a plurality of displacement coefficients based on the at least one coefficient block and a second scan order; and
determining a reconstructed mesh based on the plurality of displacement coefficients and a decimated mesh of the current frame.

2. The method according to claim 1,
wherein the first scan order comprises a reverse scan order of a raster scan order.

3. The method according to claim 1,
wherein the second scan order comprises a reverse scan order of a Z-scan order.

4. The method according to claim 1, wherein the method further comprises:
determining a plurality of displacement vectors based on the plurality of displacement coefficients; and
determining the reconstructed mesh based on the plurality of displacement vectors and the decimated mesh.

5. The method according to claim 4, wherein the method further comprises:
performing inverse wavelet transform processing on the plurality of displacement coefficients to determine the plurality of displacement vectors.

6. The method according to claim 4, wherein the method further comprises:
performing subdivision processing on the decimated mesh to determine a subdivided mesh of the current frame; and
determining the reconstructed mesh based on the plurality of displacement vectors and the subdivided mesh.

7. The method according to claim 1,
wherein the coefficient block is a square block comprising at least one unit block, wherein the unit block comprises 2×2 displacement coefficients.

8. The method according to claim 7,
wherein the displacement coefficients in the unit block are arranged in ascending order of frequency, wherein a high-frequency displacement coefficient is located on a left side and/or an upper side of a low-frequency displacement coefficient.

9. The method according to claim 7,
wherein the displacement coefficient information comprises at least one level of details LOD comprising the at least one coefficient block.

10. The method according to claim 8,
wherein the displacement coefficient information comprises at least one level of details LOD comprising the at least one coefficient block.

11. An encoding method, applied to an encoder, wherein the method comprises:
determining a plurality of displacement coefficients based on a plurality of displacement vectors of a current frame;
sequentially traversing the plurality of displacement coefficients based on a second scan order to determine at least one coefficient block;
determining displacement coefficient information of the current frame based on the at least one coefficient block and a first scan order; and
writing the displacement coefficient information into a bitstream.

12. The method according to claim 11,
wherein the first scan order comprises a reverse scan order of a raster scan order.

13. The method according to claim 11,
wherein the second scan order comprises a reverse scan order of a Z-scan order.

14. The method according to claim 11, wherein the method further comprises:
performing wavelet transform processing on the plurality of displacement vectors to determine the plurality of displacement coefficients.

15. The method according to claim 11,
wherein the coefficient block is a square block comprising at least one unit block, wherein the unit block comprises 2×2 displacement coefficients.

16. The method according to claim 15,
wherein the displacement coefficients in the unit block are arranged in ascending order of frequency, wherein a high-frequency displacement coefficient is located on a left side and/or an upper side of a low-frequency displacement coefficient.

17. The method according to claim 15, wherein:
the displacement coefficient information comprises at least one LOD comprising the at least one coefficient block.

18. The method according to claim 16, wherein:
the displacement coefficient information comprises at least one LOD comprising the at least one coefficient block.

19. The method according to claim 11,
wherein the displacement vector is determined by using a subdivided mesh of the current frame and an original mesh of the current frame, wherein decimation processing is performed on the original mesh to determine a decimated mesh, and subdivision processing is performed on the decimated mesh to determine the subdivided mesh.

20. A non-transitory computer-readable storage medium, storing a bitstream obtained by:
determining a plurality of displacement coefficients based on a plurality of displacement vectors of a current frame;
sequentially traversing the plurality of displacement coefficients based on a second scan order to determine at least one coefficient block;
determining displacement coefficient information of the current frame based on the at least one coefficient block and a first scan order; and
writing the displacement coefficient information into a bitstream.
